(19) United States
(12) Patent Application Publication
(10) Pub. No.: US 2024/0078597 A1
(43) Pub. Date: Mar. 7, 2024

(54) ARTIFICIAL INTELLIGENCE FINANCIAL RESTRUCTURING

(71) Applicant: INTERNATIONAL BUSINESS MACHINES CORPORATION, Amonk, NY (US)

(72) Inventors: Ana Paula Appel, São Paulo (BR); Aline Bossi, Piracicaba (BR); Anderson Luis de Paula Silva, Cotia (BR); Andrea Aparecida Crespo, Santo Andre (BR); Bruno Vieira Rosa, Hortolândia (BR); Carlos Eduardo Buzeto, Osasco (BR); Carlos Lessandro Lopes Rischioto, São Paulo (BR); Jorge Damiao Barbosa das Chagas, Sao Jose dos Campos (BR); Paula Fernanda Pereira, São Paulo (BR); Rogerio Cesar Barbosa dos Santos da Silva, São Paulo (BR)

(21) Appl. No.: 17/939,481

(22) Filed: Sep. 7, 2022

(51) Int. Cl. G06Q 40/02

(52) U.S. Cl. CPC G06Q 40/02

(57) ABSTRACT

In a first aspect of the invention, there is a computer-implemented method including: training, by a computing device, a machine learning (ML) model on a financial data set comprising data on financial behavior applicable to repaying debts; entering, by a computing device, an interaction with a user regarding renegotiating a debt; and generating, by the computing device, a proposed payment plan for the debt, based on user data of the user, and using the ML model trained on the financial data set.

### BACKGROUND

Aspects of the present invention relate generally to machine learning (ML) and artificial intelligence (AI), and, more particularly, to ML/AI systems, methods, and devices for automated debt servicing agreement renegotiation and settlement.

Individuals, businesses, and other entities who use debt financing in any form sometimes face changing circumstances that affect their repayment of that debt financing. Banks, other financial institutions, and other creditor entities sometimes renegotiate payment plans on debts with their borrowers.

### SUMMARY

In a first aspect of the invention, there is a computer-implemented method including: training, by a computing device, a machine learning (ML) model on a financial data set comprising data on financial behavior applicable to repaying debts; entering, by the computing device, an interaction with a user regarding renegotiating a debt; and generating, by the computing device, a proposed payment plan for the debt, based on user data of the user, and using the ML model trained on the financial data set.

In another aspect of the invention, there is a computer program product including one or more computer readable storage media having program instructions collectively stored on the one or more computer readable storage media. The program instructions are executable to: train a machine learning (ML) model on a financial data set comprising data on financial behavior applicable to repaying debts; enter an interaction with a user regarding renegotiating a debt; and generate a proposed payment plan for the debt, based on user data of the user, and using the ML model trained on the financial data set.

In another aspect of the invention, there is system including a processor set, one or more computer readable storage media, and program instructions collectively stored on the one or more computer readable storage media. The program instructions are executable to: identify, in response to a dialog with a user, debts associated with the user; receive, from a plurality of sources, information associated with the user, comprising transactions data, credit score, debts, history of payments, behavior of payments, income, social network information including travel history, consumption habits, employment history, possibility of promotion, and banking; generate a summary of the user using the information associated with the user; generate a machine learning (ML) model of the user, using the summary of the user; update the ML model of the user, in response to receiving responses from the user to a set of prompts, the prompts comprising preferred day of payment, and preferred installment payment amount; generate a debt payment plan proposal, using the ML model of the user; and output the debt payment plan proposal.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 shows a flowchart of an exemplary method in accordance with aspects of the invention.

FIG. 4 shows an example environment comprising an AI debt renegotiation system and example users with example user devices, and showing example components of an AI debt renegotiation system, in accordance with various examples of this disclosure.

FIG. 5 shows a block diagram of an example method that may be performed by systems and devices of this disclosure, such as an AI debt renegotiation system, in accordance with various examples of this disclosure.

FIG. 6A shows a flowchart for an example method that an AI debt renegotiation system may perform, in accordance with various examples of this disclosure.

FIG. 6B shows an analogous example time sequence of graphical user interface (GUI) states rendered by an AI debt renegotiation system browser-rendered web page or application running on a user device in the form of a mobile phone during a debt renegotiation process, in accordance with various examples of this disclosure.

FIG. 7 shows a conceptual diagram of an example AI debt renegotiation system in terms of its machine learning software and models, ingested data, and resulting outputs, in accordance with various examples of this disclosure.

FIG. 8 shows a conceptual diagram of an example architecture of an example AI debt renegotiation system, operating across a service provider public cloud computing environment, a corporate computing environment, and an app linking resources from both of service provider public cloud computing environment and corporate computing environment, and running on a user device, in accordance with various examples of this disclosure.

FIG. 9 shows an illustrative example software development interface, showing examples of user variables table, a decision string, software module menu, and example simple if-then rule software modules, in accordance with various examples of this disclosure.

FIG. 10 depicts conceptual diagrams of an ML software process flow for data science pipeline and electronic decision automation (EDA) creation and processing, in accordance with various examples of this disclosure.

### DETAILED DESCRIPTION

Aspects of the present invention relate generally to an artificial intelligence (AI) system that is able to make an automated debt renegotiation and settlement and debt financial restructuring with a client, and, more particularly, to operate an AI dialogue agent that is enabled to have conversations with clients and make renegotiated plan proposals to the clients. The AI dialogue agent may be powered by an AI debt renegotiation system based on, in an illustrative example, a predictive real-time model that may analyze client information (past and present), in accordance with all applicable data privacy laws, regulations, best practices, and any other applicable data privacy criteria (“data privacy criteria”) and all applicable user opt-ins, to determine and predict salient behavior of the client. This may include, for example, if the client has a debt history, if the client experienced what was probably only a temporary setback, and if the client has or is likely to have substantial ongoing debts and/or financial distress spreading into the future. (Clients may also be referred to as customers or users herein.) According to aspects of the invention, an AI debt renegotiation system may enter an interaction with a user regarding renegotiating a debt. In embodiments, an AI debt renegotiation system may generate a proposed payment plan for the debt, based on user data of the user, and use a machine learning (ML) model trained on a data set of financial behavior applicable to repaying debts. In embodiments, an AI debt renegotiation system may enable the user to select and e-sign a valid new debt renegotiation agreement generated by the AI debt renegotiation system, and the AI debt renegotiation system may record that agreement in association with the client's account with a financial institution or other creditor entity or financial servicing intermediary company. In this manner, implementations of the invention may perform automated renegotiation and settlement of outstanding debts, providing inventive new financial advantages for consumers and business owners seeking to service and resolve debts, and for financial institutions and technology service providers seeking to assist with such servicing and resolving of debts.

Various examples of this disclosure are directed to a computer-implemented process for generating a debt resolution proposal. The computer-implemented process may include: in response to a dialog with a user, identifying debts associated with the user; receiving, from a plurality of sources, information associated with the user including transactions data, credit score, debts, history of payments, behavior of payments, income, social network information including travel history, consumption habits, employment history, possibility of promotion, and banking; generating a summary of the user using information received; and generating a machine learning model using the summary of the user. The computer-implemented process may further include: in response to receiving responses from the user to a set of prompts, including preferred day of payment, and installment preferences, updating the machine learning model; generating a debt payment proposal using the machine learning model; and, in response to presenting the debt payment proposal to the user, receiving input from the user including time needed to respond, and terms for repayment. The computer-implemented process may further include: in response to the input received from the user, determining to modify the debt payment proposal to create a new debt payment proposal; presenting the new debt payment proposal to the user including a set of predetermined inducements to accept the new debt payment proposal; and, in response to the user accepting the new debt payment proposal, monitoring installment payments including reinforcement using payment reminders.

Resolving debts sometimes poses issues, including between large financial institutions and their clients. On the client side, it may be hard to be understandable and get a proposal that fits their current budgets. For financial institutions, dealing and renegotiating debts with clients who have small or medium-sized debts may tend to be time-consuming and relatively expensive to address in terms of the cost of personnel time to discuss with clients, analyze their financial situations, and generate reasonable new renegotiated debt settlement payment plans that may be advantageous for both the institution and the client. The time cost of the personnel time may be substantial relative to the size of the debt and to the institution's profits from it, making it challenging to determine when and how deploying such personnel time on such debt renegotiation efforts are cost-effective for the financial institution, or for a servicing or intermediary company, depending on the terms of their servicing remuneration.

In order to solve shortcomings of existing, conventional debt renegotiation processes, a machine learning method coupled with a cognitive assistant, in accordance with aspects of the present disclosure, is able to understand the user and propose a debt payment installment that will be good for the user and for the financial institution, among other novel and inventive advantages. An AI debt renegotiation system in accordance with various examples of this disclosure may comprise and/or use one or more ML models, including debt settlement proposal models, that will personalize the proposal based on user information, in an AI dialogue agent conversation, so it is a self-service model for the client, and imposes no personnel time cost for the creditor entity or their servicing intermediary. The client also benefits from the comfort of interacting with a machine intelligence rather than having to talk with a human stranger about something that may be difficult and personal for them to discuss. An AI debt renegotiation system of this disclosure may be engineered based on the user's data to make the user comfortable to form an agreement on a payment plan that the AI is able to tailor for the user, and their preferences and situation, using AI training that may enable sophistication in such interactions beyond what the creditor entity may be able to gain from otherwise comparable human employee debt negotiators. An AI debt renegotiation system of this disclosure may benefit the creditor entities such as financial institutions in optimizing proposals that the client will be able to pay, such that AI debt renegotiation systems of this disclosure may boost repayment and profitability from distressed debt, and with lower personnel time costs to do so, in various examples, among other novel and inventive advantages.

This disclosure further relates to a problem of a conversation agent being able to perform a debt renegotiation and settlement with clients, on behalf of an organization. In particular, this disclosure presents automated ways of creating personalized proposals based on artificial intelligence and available information about the debt holder, among other advantages, and consistent with data protection criteria and user-selected opt-ins.

Illustrative systems and methods introduced in systems of this disclosure are able to (1) retrieve client information from internal and external sources, (2) consolidate the data and process it to create a financial profile (e.g., summary), (3) interact with the client via an interactive AI dialogue agent to gather complementary information (e.g., best day to pay, number of installments), and (4) present the proposal, and influence on its acceptance. Throughout the debt renegotiating process, and consistent with all applicable data privacy criteria and user-selected opt-ins, implementations of this disclosure may use machine learning algorithms to feed the conversation agent with client-related information so that it can offer a suitable proposal more likely to be paid, taking into consideration the debt holder capabilities.

Intelligent debt renegotiating software and systems of this disclosure may resolve shortcomings of conventional methods and unlock unexpected new cloud AI-enabled facilitation of debt renegotiation and settlement, with little or any creditor-side human intervention needed in the direct process, thereby benefiting both creditors and debtors, in ways unforeseen and impossible to implement without AI and cloud computing, and that may be impossible to perform mentally in a human mind. Implementations of this disclosure may also enable novel and inventive advantages uniquely enabled by ML and AI that may perform beyond what is possible to achieve with conventional, non-AI, algorithmic software. Implementations of this disclosure incorporate the inventive insight that renegotiating debts poses clear goals, such as optimizing for customers to be able to return quickly to good credit standing, and for creditor entities to optimize for repayment and profitability of outstanding credit, in a field rich with large data sets, and so is ripe for uniquely advantageous application of AI. In an illustrative example, an AI debt renegotiation system of this disclosure may incorporate one or more neural networks trained with large data sets of financial data and behavior, and trained to optimize for goals such as the above, thereby tuning weights and biases of large numbers (e.g., millions) of nodes of the neural networks, using ML training techniques such as backpropagation and stochastic gradient descent to perform an efficient search of the software program phase space for an optimized state of the neural network to achieve the assigned goals, based on all of the training data. Such incorporation into the AI of optimization toward a stated goal using such sophisticated AI training techniques, based on, e.g., millions of data points from training data, and encoded in, e.g., millions of weights and biases of nodes in a software neural network, may be categorically impossible to duplicate or replicate in any form of mentally performed process in human minds. An AI debt renegotiation system of this disclosure may further be subjected to ongoing and/or continuous training based on ongoing user financial behavior data that it itself collects in the process of operating, thereby learning from its own experience, becoming increasingly optimized and intelligent as it goes.

It should be understood that, to the extent implementations of the invention collect, store, or employ personal information provided by, or obtained from, individuals (for example, financial account login credentials, information about personal debts, other personal financial information, social media identification and information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

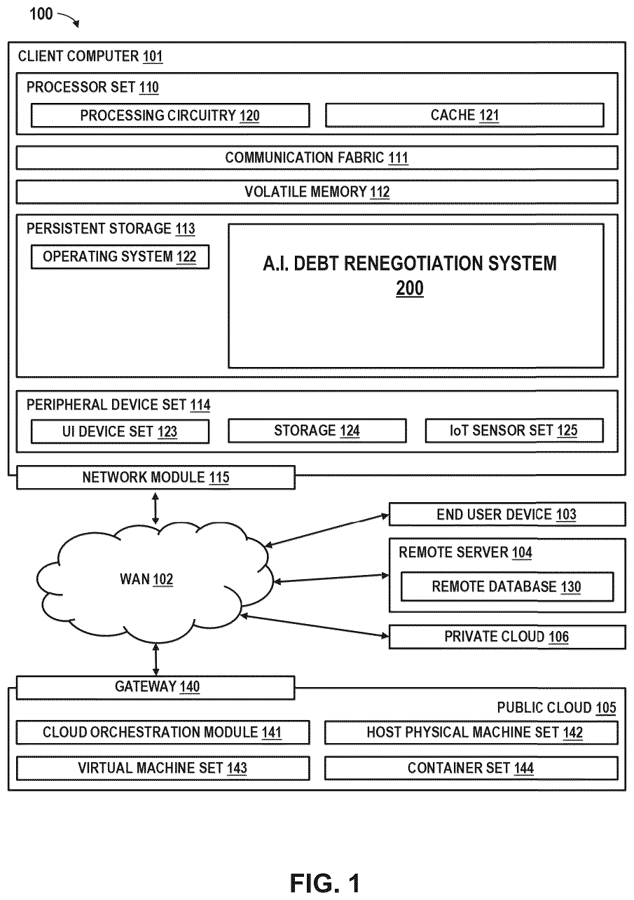

FIG. 1 depicts a computing environment 100 according to an embodiment of the present invention. General aspects of the figures and descriptions may be considered as follows.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI debt renegotiation system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

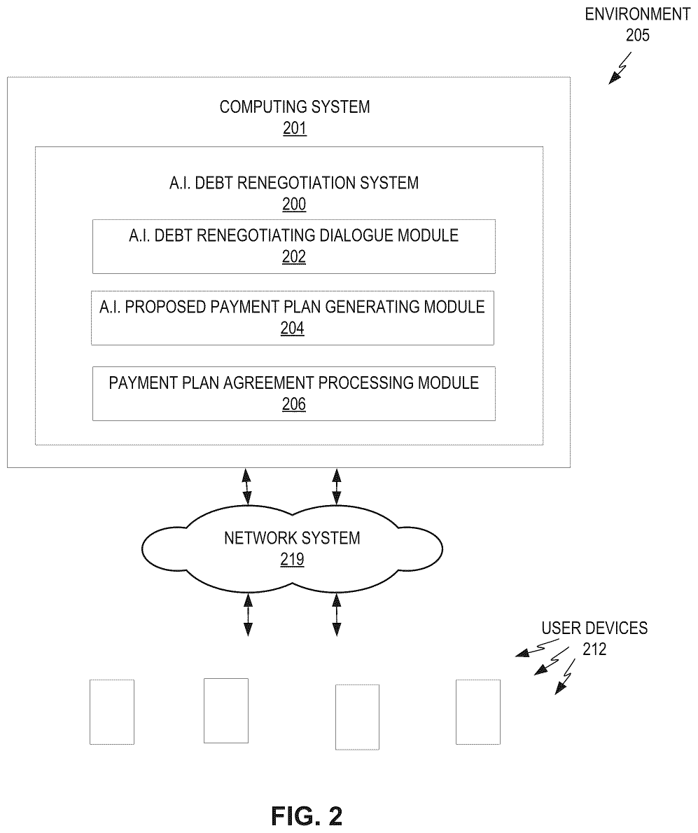

FIG. 2 shows a block diagram of an exemplary environment 205 in accordance with aspects of the invention. In embodiments, the environment 205 includes a computing system 201 that hosts an AI debt renegotiation system 200. Computing system 201 may include one or more elements of computer 101 of FIG. 1. According to aspects of the invention, AI debt renegotiation system 200 may include an AI debt renegotiating dialogue module 202, an AI proposed payment plan generating module 204, and a payment plan agreement processing module 206. In embodiments, AI debt renegotiation system 200 may engage debt renegotiation conversations via user devices 212 via network system 219 (e.g., the Internet, mobile service providers, WiFi routers), and generate proposed payment plans for users' debts, based on user data of the users, and use machine learning (ML) model trained on data sets of financial data and behavior applicable to repaying debts. In embodiments, AI debt renegotiation system 200 may enable users to select and e-sign a valid new debt renegotiation agreement generated by AI debt renegotiation system 200. AI debt renegotiation system 200 may record those agreements in association with the users' accounts with banks or other financial institutions or other creditor entities or financial servicing intermediary companies.

In embodiments, computing system 201 of FIG. 2 comprises AI debt renegotiating dialogue module 202, AI proposed payment plan generating module 204, and payment plan agreement processing module 206, each of which may comprise modules of the code of block 200 of FIG. 1. These modules of the code of block 200 are executable by the processing circuitry 120 of FIG. 1 to perform the inventive methods as described herein. Computing system 201 of FIG. 2 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

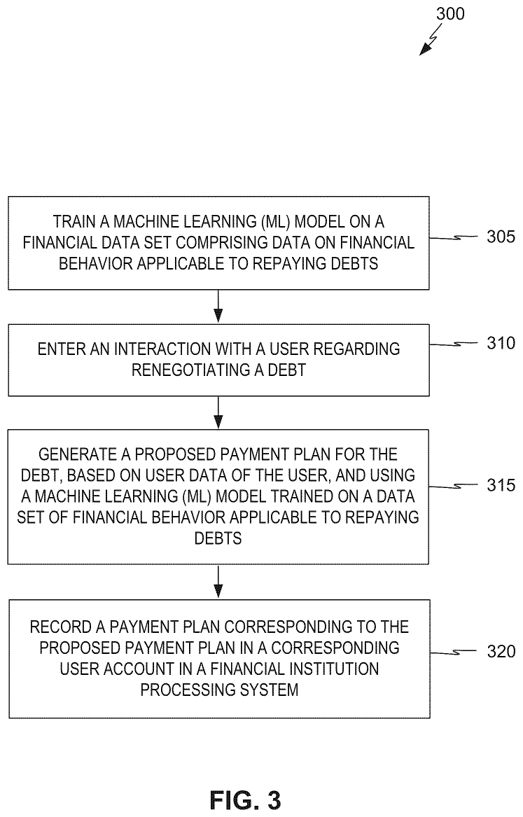

FIG. 3 shows a flowchart of an exemplary method in accordance with aspects of the present invention. Steps of the method may be carried out in the environment of FIG. 2 and are described with reference to elements depicted in FIG. 2.

At step 305, AI debt renegotiation system 200 trains a machine learning (ML) model on a financial data set comprising data on financial behavior applicable to repaying debts. At step 310, AI debt renegotiation system 200 enters an interaction with a user regarding renegotiating a debt. At step 315, AI debt renegotiation system 200 generates a proposed payment plan for the debt, based on user data of the user, and using a machine learning (ML) model trained on a data set of financial behavior applicable to repaying debts. At step 320, AI debt renegotiation system 200 records a payment plan corresponding to the proposed payment plan in a corresponding user account in a financial institution processing system. In embodiments, and as described with respect to FIG. 2, AI debt renegotiation system 200 comprises AI debt renegotiating dialogue module 202, AI proposed payment plan generating module 204, and payment plan agreement processing module 206. In various examples, AI debt renegotiating dialogue module 202 comprises a conversation agent, trained on a machine learning (ML) conversation model, and configured to interact with customers to output offers of the proposed payment plans, and which AI debt renegotiation system 200 operates to communicate with customers. In embodiments, AI debt renegotiation system 200 may engage debt renegotiation conversations via user devices 212 via network system 219 (e.g., the Internet, mobile service providers, WiFi routers), and generate proposed payment plans for users' debts, based on user data of the users, and use machine learning (ML) model trained on data sets of financial data and behavior applicable to repaying debts. In embodiments, AI debt renegotiation system 200 may enable users to select and e-sign a valid new debt renegotiation agreement generated by AI debt renegotiation system 200. AI debt renegotiation system 200 may record those agreements in association with the users' accounts with banks or other financial institutions or other creditor entities or financial servicing intermediary companies.

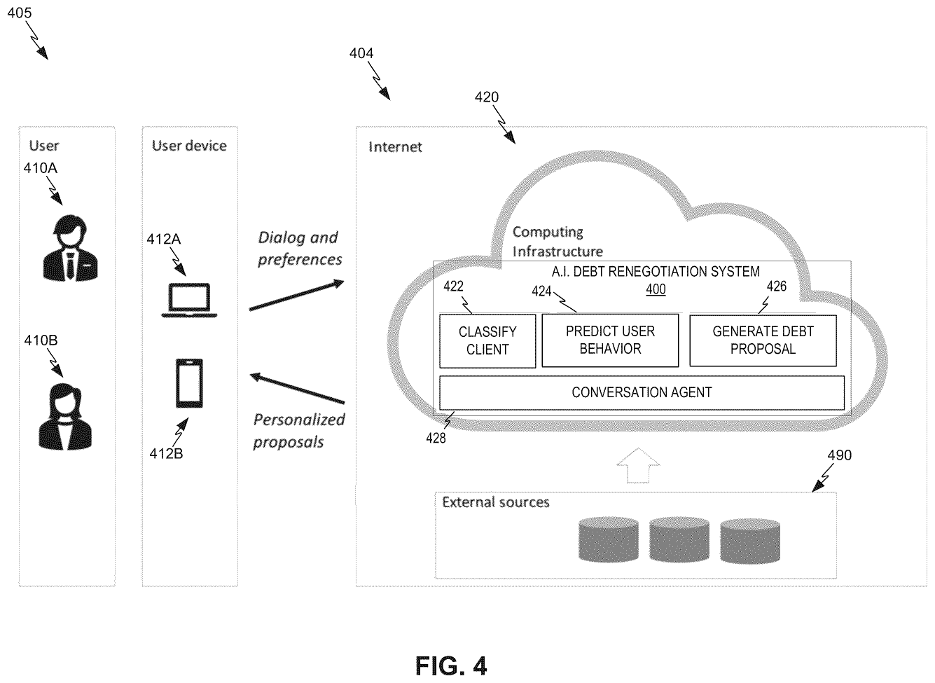

FIG. 4 shows an example environment 405 comprising an AI debt renegotiation system 400 and example users 410A, 410B (“users 410”) with example user devices 412A, 412B (“user devices 412”), and showing example components of AI debt renegotiation system 400, in accordance with various examples of this disclosure. Users 410 may be business owners, business managers, or individual consumers, who may be interested in renegotiating a debt with a financial institution, for example. User devices 412 may be computing devices that users 410 directly interact with, and which may include laptop computers, desktop computers, or mobile phones or other mobile devices (omnichannel), for example. AI debt renegotiation system 400 includes AI debt renegotiation system computing infrastructure 420, which may include or be included in a group of computing resources that may host an AI debt renegotiation system solution and/or other AI debt renegotiation system elements, and may execute data gathering and prediction components, for example. AI debt renegotiation system 400 may be connected with user devices 412 via the Internet 404, including any elements thereof, which may enable communication among user devices 412, external data sources 490, and the solution core of AI debt renegotiation system 400. AI debt renegotiation system 400 may be another example of an AI debt renegotiation system of this disclosure, and may overlap with AI debt renegotiation system 200 of FIGS. 1 and 2, or be identical with, or be a different implementation than AI debt renegotiation system 200 of FIGS. 1 and 2, in various examples.

AI debt renegotiation system 400 may include modules, which may each include software, hardware, and computing resources of any kind, including a customer classifying module 422, a user behavior predicting module 424, a debt proposal generating module 426, and a conversation agent module 428. Customer classifying model 422 may include a machine learning model to analyze client information to generate customer profiles (e.g., summaries). User behavior predicting module 424 may include a machine learning model to identify probabilities of customers to honor their debts, may use a variety of sources of inputs, including the output of customer classifying module 422. Customer classifying module 422 and user behavior predicting module 424 may either or both also use as inputs data from external data sources 490 in various examples. Conversation agent module 428 may include and be trained on ML models of human conversation in one or more human natural languages, and may be especially adapted for carrying out conversations about financial restructuring and debt renegotiation, in various examples. External data sources 490 may include companies, entities, and other sources that own and/or manage and distribute private and/or public customer information. AI debt renegotiation system 400 may retrieve data from external data sources 490 and use it, consistent with applicable data privacy laws, regulations, and permissions, to enrich existing client data. Example of such external data sources 490 may include open banking and/or credit score reporting companies. Debt proposal generating module 426 may include a machine learning model to create personalized proposals for the customers based on the outputs of user behavior predicting module 424 and debt proposal generating module 426.

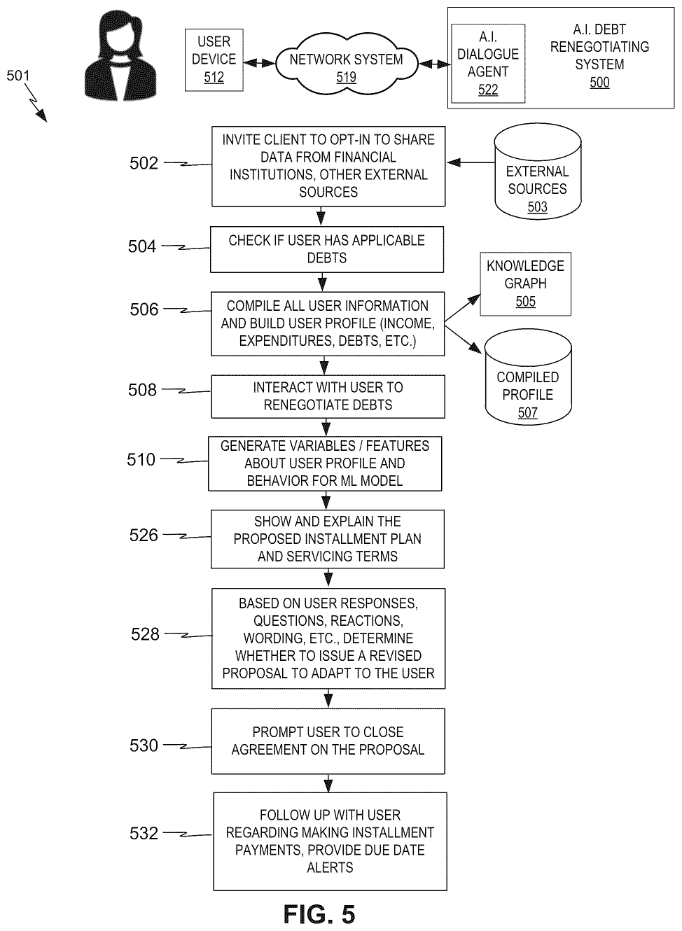

FIG. 5 shows a block diagram of an example method 501 that may be performed by systems and devices of this disclosure, such as AI debt renegotiation system 500 shown in FIG. 5, and/or AI debt renegotiation systems 200, 400 shown in FIGS. 1, 2, and 4, in accordance with various examples of this disclosure. AI debt renegotiation system 500 of FIG. 5 may be an at least partly overlapping implementation of this disclosure with AI debt renegotiation systems 200, 400 shown in FIGS. 1, 2, and 4, in various embodiments. The description of method 501 as follows illustratively refers to the example of AI debt renegotiation system 500.

In method 501, a user initiates accessing and using AI debt renegotiation system 500. AI debt renegotiation system 500 may communicate with a user device 512 of the user via an AI intelligent dialogue agent 522, with communications and data transmitted via a network system 519, for example. AI debt renegotiation system 500 may confirm or enter all applicable opt-ins to share personal data from financial institutions and/or other external sources 503, as described above (502). AI debt renegotiation system 500 checks whether this user has accessibly known debts, and if yes, proceeds (504). AI debt renegotiation system 500 collects user information from applicable data sources conforming to all applicable data privacy and user-selected opt-in criteria (506), illustratively including but not limited to: financial account transaction data of any one or more financial accounts (e.g., bank checking and savings accounts, mortgage loan accounts, credit card accounts, other loan accounts, securities trading accounts, retirement savings accounts), credit score, debts, payment history, payment behavior, income, social network information (e.g., traveling and consume habits, work information, status as employed or not employed, possibility of promotion), and open banking information.

AI debt renegotiation system 500 compiles data relevant to the user from all of the applicable data sources to create a compiled user profile (e.g., summary) 507. AI debt renegotiation system 500 saves this user profile 507, including applicable information, which may include in forms such as variables and/or a knowledge graph 505 (further explained below). AI debt renegotiation system 500 may use the user profile 507 and knowledge graph 505 in interacting with the user to renegotiate the user's debts (508), and may apply all applicable such data and information, which may be collectively referred to as user profile data, to one or more machine learning (ML) models (510). AI debt renegotiation system 500 may apply such user profile data to one or more ML models, and may thereby generate probabilities or ensemble predictions of particular users successfully following through on renegotiated payment plans, in some examples.

AI debt renegotiation system 500 may thereby generate ML classification predictions for the user such as the following. AI debt renegotiation system 500 may classify the user into a selected payment likelihood category, such as whether the user is a good payer or not. Generating this classification prediction may include, for example, using one or more machine learning models (e.g., time series, recommendation, classifier) to process historical payment information and predict the payment behavior of the user. AI debt renegotiation system 500 may classify whether the user is managing finances consistently with paying down current debts or may apparently give signs of being compulsive to make debts. For example, AI debt renegotiation system 500 may analyze if the user has several open debts and has also posted recent images or other posts in social media about traveling, and/or has recently bought a new car or a lot of things on credit cards. AI debt renegotiation system 500 may analyze applicable, opted-in finance data to look at user data, credit score, and analogous data, and use each type of score as a variable or feature in one or more ML models.

AI debt renegotiation system 500 may analyze whether the user is unemployed but has a large chance to be reallocated or gain new employment in the near future, using both existing data, and predictions generated using ML models, which may be trained on large data sets of consumer financial behavior and then fine-tuned based on the behavior of the individual user, in various examples. For example, AI debt renegotiation system 500 may analyze user resume information (e.g., from one or more professional-related social networks, a company profile) to determine if the user has a high probability of having new employment with significant income in the near future. AI debt renegotiation system 500 may analyze if the user is enrolled in school and has a high chance of graduating and obtaining new employment with significant income in the near or long term. AI debt renegotiation system 500 may analyze if the user has potential investment income that has been dormant but is likely to become an active income source in the near future, such as if the user historically has rental income or business income that has been interrupted but is likely to resume. AI debt renegotiation system 500 may calculate and determine a probability that one or more rental properties have been vacant but are likely to be occupied by new lessors providing new rental income again in the near future, or a probability that a business that has historically been profitable and has recently been unprofitable is likely to return to profitability as a source of income again in the near future.

Consistent with all applicable data privacy criteria and user-selected opt-ins, AI debt renegotiation system 500 may analyze the user's social media regarding intent to pay down debts, as well as capability of doing so, such as by applying ML analysis tools such as natural language understanding and sentiment analysis to the user's social media posts, and in combination with greater integrated predictive models of the user's financial behavior as a whole based on all available relevant data and ML predictive modeling. For example, AI debt renegotiation system 500 may analyze if the user has posted expressions on social media of intent to pay down debts or of participating in financial education in some form, or on the other hand, if the user has posted expressions on social media stating intent to service existing debts just enough to be able to engage in additional debt financing.

AI debt renegotiation system 500 may perform these or further forms of analysis, and may initiate a response to the user. AI debt renegotiation system 500 may interact with the user, via an AI intelligent dialogue agent 522 for instance, and ask about how the user would like to negotiate a new debt servicing agreement. AI debt renegotiation system 500 may ask questions to check and verify correct user information and identity credentials, and may generate a new proposed payment plan with new debt servicing terms (526) based on predictions, for terms such as a best day of each month for payments to be due, preference of payment installment value, and/or a number of installment payments. If the user has previously accessed AI debt renegotiation system 500, AI debt renegotiation system 500 may access and use previous information as may still be applicable about value and payment installments. AI debt renegotiation system 500 may also pose questions to the user about why the user would like to renegotiate servicing terms for the applicable debt, such as whether the value of existing installment payments is currently too high for the user's budget, and/or whether the user has recently experienced a job loss, health issues, or issues servicing other debts, for example.

AI debt renegotiation system 500 may thus generate several variables and/or features about a user profile, and apply one or more machine learning models to generate a new proposal for a renegotiated debt payment plan (“proposal”) for the user. AI debt renegotiation system 500 may generate and deliver outputs to a user device to present the proposal and an explanation of its terms to the user.

AI debt renegotiation system 500 may receive and process aspects of the user's reactions to the proposal, such as questions about the proposal, time to react, language, and wording. If the user poses questions about the proposal rather than agreeing to the proposal, AI debt renegotiation system 500 may process the user's reactions, together with other applicable data, and determine whether and with what terms to generate another new proposal, with one or more variations to the terms relative to the prior proposal, to adapt to the user's requests and/or other reactions (528).

AI debt renegotiation system 500 may also generate communications to prompt the user to close an agreement on the proposal (530). In one example, AI debt renegotiation system 500 may prompt the user by explaining that accepting the proposal and paying on its terms may result in positive reporting for the user by credit reporting bureaus. In another example, AI debt renegotiation system 500 may prompt the user by offering incentives in exchange for forming an agreement on the proposal, such as an opportunity to participate in a financial education program and/or a loyalty rewards program, and/or to receive compensation or a reward, such as a gift, or cash back, in exchange for finalizing agreement on the proposal.

AI debt renegotiation system 500 may record a user finalization of agreement on the proposal, such as by receiving the user's electronic signature on an electronic contract document reciting the terms of the proposal. AI debt renegotiation system 500 may transmit the finalized, signed electronic contract document to any applicable entities, such as a financial institution or other entity that holds the debt and/or that services processing payments on the debt, and in association with the user's account or accounts with such financial institutions or other entities.

AI debt renegotiation system 500 may also continue to engage in positive interactions with the user during the course of executing on the newly negotiated and agreed payment plan (532), consistent with any applicable data privacy criteria and user-selected opt-ins. For example, AI debt renegotiation system 500 may follow and track the user's installment payments, generate payment reminders and due date alerts for the user, send the user congratulatory notes in response to payments being made, and/or perform other interactions to reinforce the user's positive performance of payments in accordance with the newly negotiated and agreed payment plan.

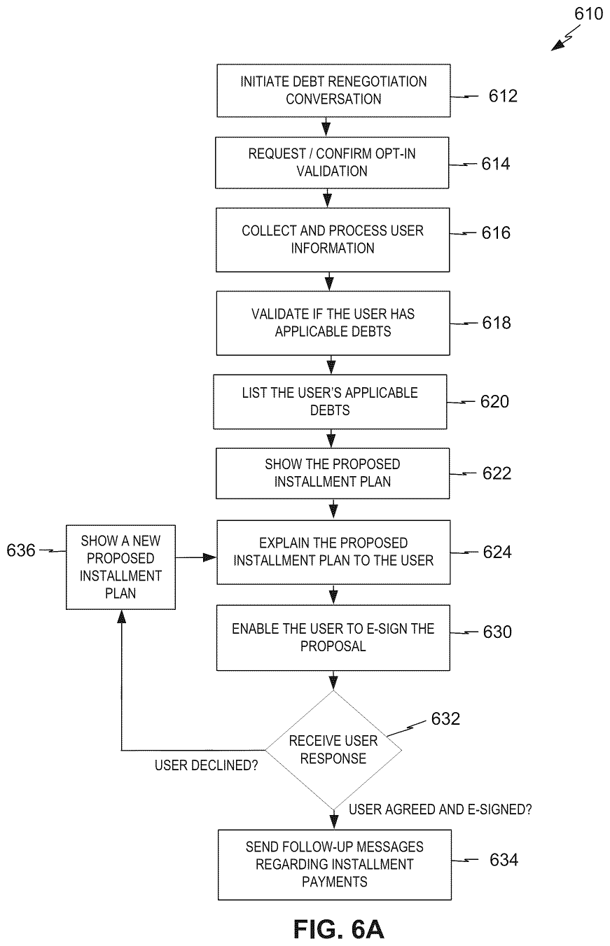

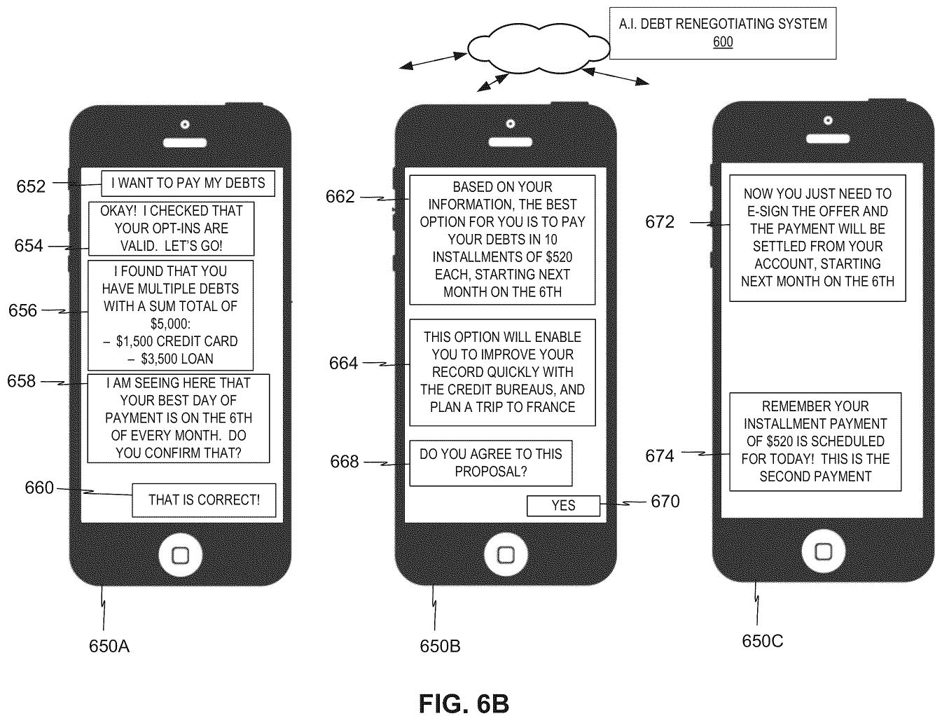

FIG. 6A shows a flowchart for an example method 610 that an AI debt renegotiation system 600 may perform, in accordance with various examples of this disclosure. AI debt renegotiation system 600 may be either an identical or partly overlapping implementation as the examples of AI debt renegotiation systems 200, 400, 500 discussed above, in various examples. FIG. 6B shows an analogous example time sequence of graphical user interface (GUI) states rendered by an AI debt renegotiation system browser-rendered web page or application (“app”) running on a user device 650 in the form of a mobile phone, shown in three different successive user interface (UI) debt renegotiation dialogue states, during a debt renegotiation process, in accordance with various examples of this disclosure. User device 650 is depicted sequentially as user device 650A in a first UI state, user device 650B in a second UI state, and user device 650C in a third UI state. AI debt renegotiation system browser-rendered web page or app running on a user device 650 may interact with and/or form part or all of AI debt renegotiation system 600 of this disclosure, in various examples, in which any one or more parts or portions of AI debt renegotiation system 600 may be hosted in one or more cloud-based resources and/or in an app running on user device 650. AI debt renegotiation system 600 and user device 650 communicate with each other via applicable communication infrastructure, which may include mobile service provider infrastructure, the Internet, and/or one or more Wi-Fi routers, for example. FIGS. 6A and 6B are each illustrative examples, and do not have a one-to-one correspondence with each other.

Making reference to both FIGS. 6A and 6B, a user may initiate contact with AI debt renegotiation system 600 by logging onto a client UI app or web page associated with AI debt renegotiation system 600 on mobile device 650 and selecting or entering and sending an initiating message 652 (e.g., “I want to pay my debts”). AI debt renegotiation system 600 may respond by initiating a conversation on debt renegotiation (612), which may include initiating applicable software processes and/or settings; requesting and/or confirming a validation that the user has selected all applicable opt-ins (614), along with an opt-in confirmation message 654 to be rendered in the client-side AI debt renegotiation system app UI; collecting and processing applicable information associated with the user (616); validating that the user has one or more outstanding debts (e.g., credit card balances, loan balances, account receivable balances) that are within the purview of AI debt renegotiation system 600 to address (618); and transmitting a listing of the addressable one or more debts to user device 650 (620), to be rendered in the client-side AI debt renegotiation system app UI as a debt listing message 656 (e.g., “I found that you have multiple debts with a sum total of $5,000-$1,500.00 Credit Card-$3,500.00 Loan”, as shown in the depiction of user device 650A). AI debt renegotiation system 600 may thus confirm validity of the one or more debts, such as with one or more corresponding creditor entities, or intermediary or servicing entities, prior to generating the proposed payment plan. AI debt renegotiation system 600 may also list which bank, lender, or other financial institution is associated with each debt, in cases in which multiple debts are owed to different financial institutions.

AI debt renegotiation system 600 may also process and score user variables based on the user's history with the one or more applicable banks or other financial institutions. AI debt renegotiation system 600 may have already previously processed such user variables using one or more ML models, to generate and/or record variables and data, consistent with applicable data privacy criteria and user-selected opt-ins, such as: credit score, a buyer score, whether the user has other debts with the bank, whether the user has one or more active credit cards, the number of days in which the user is in default in one or more credit accounts, if applicable, an account type, a self-contradictory behavior score, and an account restriction score, for example. The buyer score may incorporate a combination of how much the user spends per month with how necessary or useful the user's purchases and expenditures are, in context of a user who has expressed intent to budget to make payments on one or more renegotiated debts, such as how much of the purchases and expenditures are on basic necessities in the user's context versus unnecessary or luxury goods and services.

AI debt renegotiation system 600 may use ML models that may include a tax model, a discount model, and/or an installment model, for example. AI debt renegotiation system 600 may incorporate information from the user's history with the one or more banks and/or other financial institutions and the user's scores on all applicable variables and data to generate a proposed day of the month as a due date for installment payments. Based on the processing described, AI debt renegotiation system 600 may generate and transmit a day of the month proposal message to user device 650, to be rendered in the client-side AI debt renegotiation system app UI as a day of the month proposal message 658, as shown in the depiction of user device 650A. The user may select or enter a message in response, agreeing to the proposed day of the month (message 660, as shown in the depiction of user device 650A), or declining the proposed day of the month and potentially proposing a different day.

AI debt renegotiation system 600 may generate and transmit a proposed installment payment plan message to user device 650 (622), along with explanatory material about the proposed installment payment plan (624), to be rendered in the client-side AI debt renegotiation system app UI as an installment payment plan message 662, as shown in the depiction of user device 650B (e.g., “Based on your information, the best option for you is to pay off your debt in ten payments of $520 each, starting next month on the 6th of the month”). AI debt renegotiation system 600 may also generate and transmit an explanation of advantages message to user device 650, to be rendered in the client-side AI debt renegotiation system app UI as explanation of advantages message 664, as shown in the depiction of user device 650B (e.g., “This option will allow you to improve your record quickly with the credit reporting bureaus, and could help you plan a trip to France soon”). AI debt renegotiation system 600 may generate and/or transmit the above messages in any of various sequential orders, and is not limited to the particular sequence shown in FIG. 6.

AI debt renegotiation system 600 may generate and transmit an agreement proposal message to user device 650, to be rendered in the client-side AI debt renegotiation system app UI as agreement proposal message 668, as shown in the depiction of user device 650B (e.g., “Do you accept this proposal?”), and enabling the user to e-sign or otherwise accept the agreement for the proposed installment payment plan (630), such as with an agreement e-signature solicitation message 672 rendered in the UI as shown in user device 650C (e.g., “Now you just need to sign to sign the offer, and the payment will be settled from your account, starting next month on the 6th”). AI debt renegotiation system 600 may thus enable a lawfully valid execution of the proposed payment plan via user device 650. AI debt renegotiation system 600 may receive a lawfully valid execution of the proposed payment plan, and record a payment plan corresponding to the proposed payment plan in a corresponding user account in a financial institution processing system, such as with a creditor entity or an intermediary or servicing entity.

The user may select or enter a message in response, agreeing to the proposed installment payment plan (e.g., message 670, “Yes,” as shown in the depiction of user device 650B), or declining the proposed installment payment plan. AI debt renegotiation system 600 may receive the acceptance or the declining of the agreement (632). If AI debt renegotiation system 600 receives a user response validly accepting the agreement, AI debt renegotiation system 600 may execute all necessary follow-up steps to proceed with the agreed-upon installment payment plan, and may also send follow-up messages to the user at appropriate times (634), such as reminders to the user, e.g., reminder message 674 as shown in FIG. 6C (e.g., “Remember your installment payment of $520 is due today! This is the second payment”).

If AI debt renegotiation system 600 receives a user input declining a proposed payment plan, AI debt renegotiation system 600 may respond by presenting a new alternative proposed installment payment plan (636), if possible, such as to reduce monthly payments. AI debt renegotiation system 600 may determine a range of variables within a possible portfolio of alternative proposed installment payment plans with acceptable terms. AI debt renegotiation system 600 may reiterate the subsequent method steps from that point, as shown in FIG. 6A.

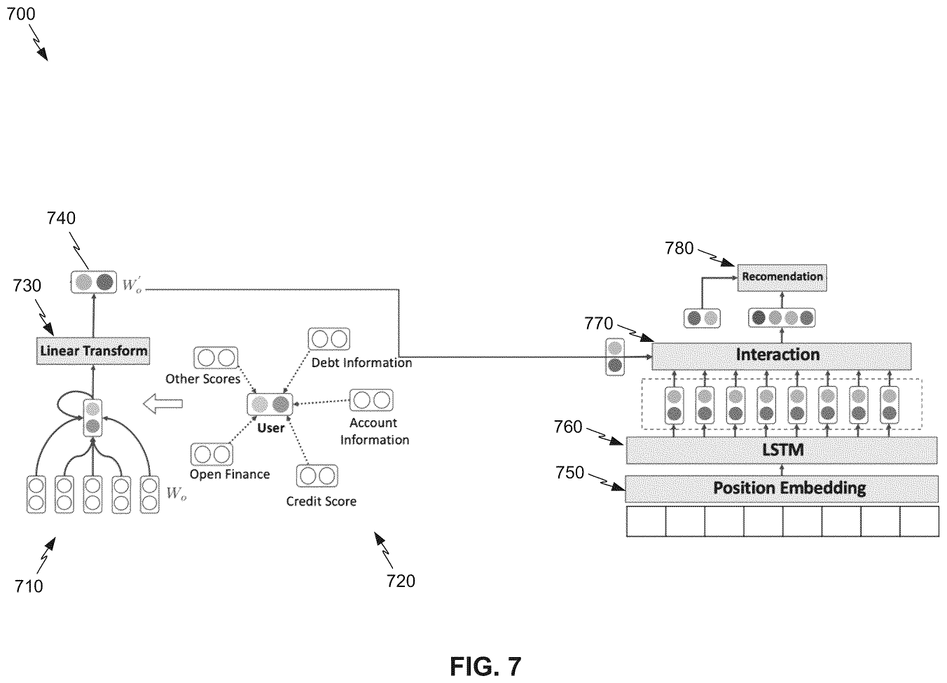

FIG. 7 shows a conceptual diagram of an example AI debt renegotiation system 700 in terms of its machine learning software and models, ingested data, and resulting outputs, in accordance with various examples of this disclosure. AI debt renegotiation system 700 may be an either wholly or partly overlapping implementation as the examples of AI debt renegotiation systems 200, 400, 500, 600 discussed above, in various examples. In this example, AI debt renegotiation system 700 includes a graph convolutional network (GCN) 710, which ingests all applicable user data 720 which conforms to all applicable data privacy criteria and user-selected opt-ins (e.g., user data and information acquired from external sources 503 in method 501 in FIG. 5). AI debt renegotiation system 700 uses all applicable user information and uses GCN 710 to generate a knowledge representation of the user (e.g., the knowledge graph 505 and compiled profile 507 as in method 501 in FIG. 5), creating the first parts of values that constitute the one or more proposed renegotiated payment plans for the user. These may include one or more proposed plans with installment payments, and a proposed plan with terms for a single lump-sum repayment. AI debt renegotiation system 700 sends the outputs of GCN 710 through linear transform 730 and generating model 740. AI debt renegotiation system 700 includes a position embedding 750 in an attention transformer architecture, which may encode installment values, installment deduction values, and interest rate values, and which is processed through a long short-term memory (LSTM) ML model 760, the outputs of which AI debt renegotiation system 700 processes together with model 740, and optionally user interaction 770, to generate one or more recommended proposals 780 (e.g., 526 in method 501 in FIG. 5, 622 in method 600 in FIG. 6A). The ML model of AI debt renegotiation system 700 thus comprises an LSTM model 760 that has processed a position embedding that encodes potential payment plan terms, and which may be comprised in AI proposed payment plan generating module 204 of AI debt renegotiation system 200 in FIG. 2, for example. AI debt renegotiation system 700 may include an ensemble of multiple algorithms, and may generate one or more best proposals for renegotiated payment plans, with installment payments and/or with a single lump sum payment.

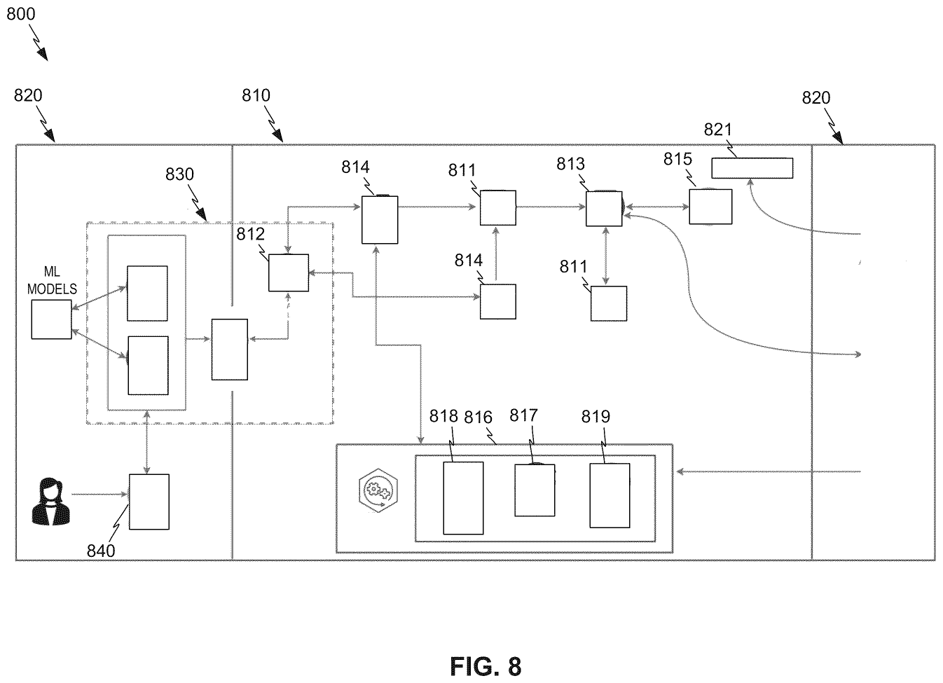

FIG. 8 shows a conceptual diagram of an example architecture of an example AI debt renegotiation system 800, operating across a service provider public cloud computing environment 810, a corporate computing environment 820 (shown in two different sections, interacting with different parts of cloud computing environment 810), and an app 830 linking resources from both of service provider public cloud computing environment 810 and corporate computing environment 820, and running on a user device 840, in accordance with various examples of this disclosure. AI debt renegotiation system 800 may be either an identical or partly overlapping implementation as the examples of AI debt renegotiation systems 200, 400, 500, 600, 700 discussed above, in various examples. An AI assistant 812 running in service provider public cloud computing environment 810 also runs within and as part of app 830, on the server side thereof.

Corporate computing environment 820 may provide all of the applicable user information context variables (e.g., from user data and information acquired from external sources 503 in method 501 in FIG. 5), consistent with all applicable data privacy criteria and user-selected opt-ins, in a secure, restricted architecture, in a table comprising all of the applicable variables (e.g., 71 variables in one example, and any other reasonable number of variables in other examples). Cloud computing environment 810 comprises an automated decision services (ADS) container platform 816, which may power automated decision-making in generating proposed renegotiated debt settlement payment plans, such as at 526 in method 501 in FIG. 5 and at 622 in method 600 in FIG. 6A, and such as to generate example proposed payment plan message 662 in FIG. 6B. ADS container platform 816 may be connected to the AI assistant 812 via Webhook deployed on managed cloud serverless platforms 814 (two examples of which are shown), and may include a containerization software suite 817, including container storage 818 and block storage 819, for example. Cloud computing environment 810 also includes secure cloud database environments 811, cloud AI software suite 813, cloud object storage 815, and cloud-hosted corporate resource group 821, in this example. These elements may support any or all of the data storage and communication aspects described above. For example, containerization software suite 817 may host any of AI debt renegotiation systems 200, 400, 500, 600, 700, and facilitate an AI debt renegotiation system performing any of the steps ascribed to any of them above. As another example, AI debt renegotiation systems 200, 400, 500, 600, and/or 700 may store user data, user information, and user profiles, such as knowledge graphs 505 and compiled user graphs 507 shown in FIG. 5, in secure cloud database environments 811.

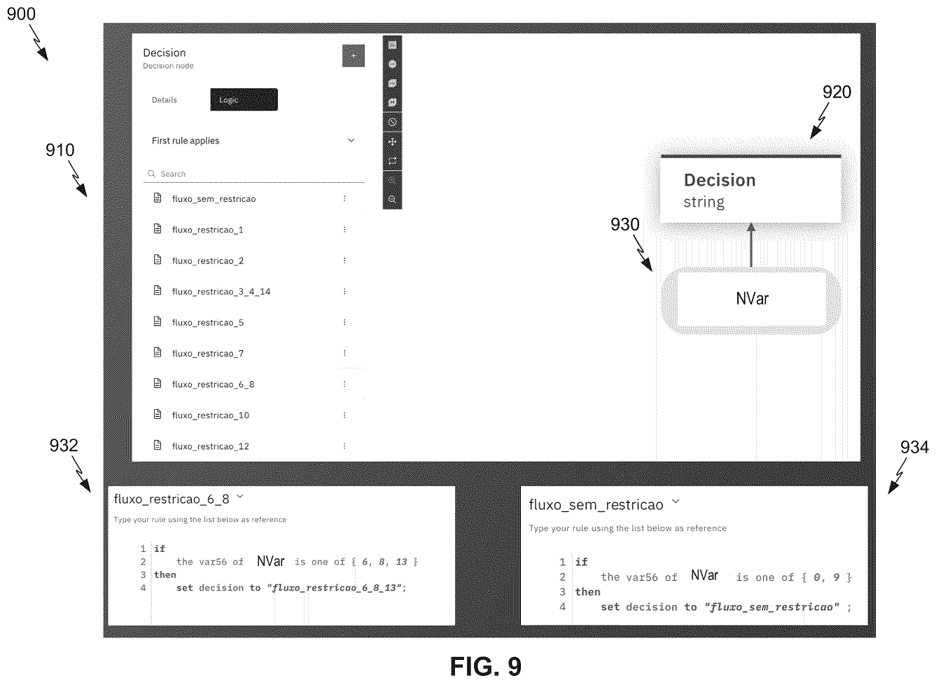

FIG. 9 shows an illustrative example software development interface 900, showing examples of user variables table 910, a decision string 920, software module menu 930, and example simple if-then rule software modules 932, 934, in accordance with various examples of this disclosure. An AI debt renegotiation system may surface software development interface 900 for a corporate user of an AI debt renegotiation system of this disclosure, who may use software development interface 900 to select or develop specific details of interaction, terms, or behavior of the AI debt renegotiation system, for example.

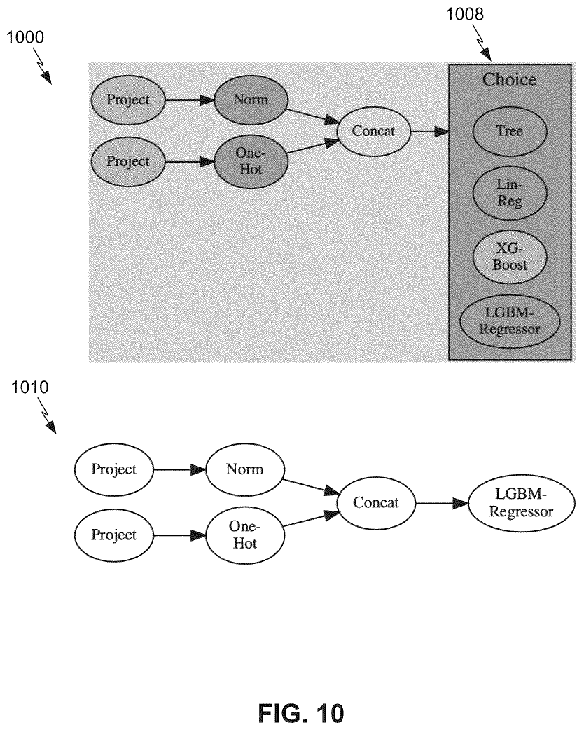

FIG. 10 depicts conceptual diagrams 1000, 1010 of an ML software process flow for data science pipeline and electronic decision automation (EDA) creation and processing, including a menu 1008 of ML regression model framework options before one is selected (1000), and after a light gradient boosted machine regressor (LGBM-regressor) framework is selected, in accordance with various examples of this disclosure. A large amount of financial behavioral data from a long period of time, collected in adherence to all applicable data privacy criteria and user-selected opt-ins, may be used for training an ML model, with portions of data also held in reserve for testing and for validation, and populating the data into a large number of applicable variables for each user in the data set, such as for account period, account status, credit card status, customer status, debt date, debt total value, inferred income, and so forth. Data from each individual project may be normalized or be subjected to one-hot encoding. Any of the four regression models shown in menu 1008 may be used, in different examples, and with appropriate values such as a deduction value, an installment value, an installment deduction value, and an interest rate value, for example.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
training, by a computing device, a machine learning (ML) model on a financial data set comprising data on financial behavior applicable to repaying debts;
entering, by the computing device, an interaction with a user regarding renegotiating a debt, the interaction comprising complementary information obtained by an artificial intelligence dialogue agent from the user;
retrieving, by the computing device, user data of the user from internal and external sources;
generating, by the computing device, a user financial profile by consolidating the complementary information and the user data of the user;
generating, by the computing device, a proposed payment plan for the debt, based on the user financial profile, and using the ML model trained on the financial data set; and
retraining, by a computing device, the ML model based on an outcome of the proposed payment plan for the debt.

2. The method of claim 1, further comprising:
recording a payment plan corresponding to the proposed payment plan in a corresponding user account in a financial institution processing system.

3. The method of claim 1, further comprising: confirming validity of applicable data privacy criteria and user-selected opt-ins, prior to accessing user data applicable to the user.

4. The method of claim 1, further comprising: confirming validity of the debt, prior to generating the proposed payment plan.

5. The method of claim 1, further comprising: enabling an agreement to the proposed payment plan via a user device.

6. The method of claim 1, further comprising: receiving an indication of an agreement to the proposed payment plan.

7. The method of claim 1, further comprising:
generating customer classifications based on data applicable to customers;
generating a customer behavior prediction module configured to generate customer behavior predictions based on data applicable to behavior of the customers;
generating proposed payment plans; and
operating a conversation agent, trained on a machine learning (ML) conversation model, and configured to interact with customers to output offers of the proposed payment plans.

8. The method of claim 1, wherein the debt comprises a plurality of debts owed to one or more creditor entities, and
wherein the proposed payment plan comprises individual proposed payment plans for each of the plurality of debts to each of the one or more creditor entities.

9. The method of claim 1, wherein the proposed payment plan comprises a first proposed payment plan, the method further comprising:
generating, by the computing device, responsive to receiving an indication of declining the first proposed payment plan, an alternative payment plan for the debt, based on the user data of the user, and using the ML model trained on the data set of financial behavior applicable to repaying debts, wherein the alternative payment plan differs in one or more terms from the first proposed payment plan.

10. The method of claim 1, wherein the ML model comprises a graph convolutional network (GCN) model based on the user data of the user.

11. The method of claim 1, wherein the ML model comprises a long short-term memory (LSTM) model that has processed a position embedding that encodes potential payment plan terms.

12. The method of claim 1, wherein generating the proposed payment plan is performed via a cloud-hosted containerization suite.

13. The method of claim 1, further comprising:
generating, by the computing device, a dialog with the user using the artificial intelligence dialogue agent; and
outputting the proposed payment plan to a user device via a cloud-hosted containerization suite and a cloud-hosted serverless platform.

14. The method of claim 1, further comprising: outputting the proposed payment plan to a user device via a server-side mobile device application integrated across a private server-side mobile device application portion and a machine learning (ML) assistant running on a public cloud.

15. A computer program product comprising one or more computer readable storage media having program instructions collectively stored on the one or more computer readable storage media, the program instructions executable to:
train a machine learning (ML) model on a financial data set comprising data on financial behavior applicable to repaying debts;
enter an interaction with a user regarding renegotiating a debt, the interaction comprising complementary information obtained by an artificial intelligence dialogue agent from the user;
retrieve user data of the user from internal and external sources;
generate a user financial profile by consolidating the complementary information and the user data of the user;
generate a proposed payment plan for the debt, based on the user financial profile, and using the ML model trained on the financial data set; and
retrain the ML model based on an outcome of the proposed payment plan for the debt.

16. The computer program product of claim 15, wherein the program instructions are further executable to: record a payment plan corresponding to the proposed payment plan in a corresponding user account in a financial institution processing system.

17. The computer program product of claim 15, wherein the program instructions are further executable to:
generate customer classifications based on data applicable to customers;
generate a customer behavior prediction module configured to generate customer behavior predictions based on data applicable to behavior of the customers;
generate proposed payment plans; and
operate a conversation agent, trained on a machine learning (ML) conversation model, and configured to interact with customers to output offers of the proposed payment plans.

18. A system comprising:
a processor set, one or more computer readable storage media, and program instructions collectively stored on the one or more computer readable storage media, the program instructions executable to:
identify, in response to a dialog with a user, debts associated with the user, the dialogue comprising complementary information obtained by an artificial intelligence dialogue agent from the user;
receive, from a plurality of sources, information associated with the user, comprising transactions data, credit score, debts, history of payments, behavior of payments, income, social network information including travel history, consumption habits, employment history, possibility of promotion, and banking, wherein the plurality of sources comprises internal and external sources;
generate a user financial profile by consolidating the complementary information and the information associated with the user;
generate a machine learning (ML) model of the user, using the user financial profile;
generate a debt payment plan proposal, using the ML model of the user;
output the debt payment plan proposal; and
retrain the ML model based on an outcome of the payment plan proposal.

19. The system of claim 18, wherein the program instructions are further executable to:
receive, in response to presenting the debt payment plan proposal to the user, input from the user including time needed to respond, and terms for repayment; and
determine, in response to the input received from the user, whether to modify the debt payment proposal to generate a revised debt payment proposal.

20. The system of claim 19, wherein the program instructions are further executable to: output the revised debt payment proposal, and a set of inducements to accept the revised debt payment proposal; and
in response to the user accepting the new debt payment proposal, monitor installment payments and output payment reminders.
